(19) United States
(12) Patent Application Publication
(10) Pub. No.: US 2024/0228287 A9
(43) Pub. Date: Jul. 11, 2024

(54) SUSTAINABLE PLASMA NITROPHOSPHATE PROCESS FOR PRODUCTION OF NITROGEN AND PHOSPHOROUS PRODUCTS AND FOR CARBON SEQUESTRATION

(71) Applicant: Nitricity Inc., Fremont, CA (US)

(72) Inventors: Nicolas H. PINKOWSKI, San Francisco, CA (US); Joshua M. MCENANEY, Fremont, CA (US); John A. SCHWALBE, Santa Clara, CA (US); Motahare ATHARIBOROUJENY, San Francisco, CA (US)

(21) Appl. No.: 18/492,464

(22) Filed: Oct. 23, 2023

Related U.S. Application Data
(60) Provisional application No. 63/418,230, filed on Oct. 21, 2022.

(51) Int. Cl. C01B 25/28; C01B 32/05

(52) U.S. Cl. CPC C01B 25/28; C01B 32/05

(57) ABSTRACT

Provided herein are systems and methods for producing nitrophosphates and mineralized carbon. Advantageously, the systems and methods are capable of sequestering carbon from the atmosphere. The systems generally include a first reactor for producing nitric acid; a mixer for mixing the nitric acid produced in the first reactor with a phosphate source, thereby producing nitro-phosphoric acid; and a second reactor for producing a solution comprising nitrophosphates and mineralized carbon, wherein the second reactor is operable to receive: the nitro-phosphoric acid from the mixer, ammonia, water, and carbon dioxide.

### CROSS-REFERENCE TO RELATED APPLICATIONS

This application claims priority to U.S. Provisional Application No. 63/418,230 entitled “SUSTAINABLE PLASMA NITROPHOSPHATE PROCESS FOR CARBON SEQUESTRATION”, filed Oct. 21, 2022, the entire contents of which are incorporated by reference herein.

### TECHNICAL FIELD

Embodiments of the present invention generally relate to a plasma-nitrogen fixation system where the fixed nitrogen may be used to create nitrogenous, phosphorous, and carbonaceous products. More specifically, aspects of the present disclosure relate to a production and carbon sequestration system with an integrated plasma system for producing nitric acid, phosphoric acid, calcium nitrate, nitrophosphates, monoammonium phosphate, diammonium phosphate, ammonium nitrate, and/or calcium carbonate, among other things.

### BACKGROUND AND INTRODUCTION

The incumbent method to produce nitrophosphate products is the so-called Odda Process, or Nitrophosphate process. This process is heavily dependent on fossil fuels and results in excessive CO₂eq emissions. As renewable sources of electricity, such as solar and wind energy, become increasingly cost-effective, electrification of chemical production processes will be able to take advantage of that low-cost and/or relatively more environmentally friendly electricity. At the same time, the world needs new methods for sequestering carbon and preventing CO₂ from becoming over-represented as a greenhouse gas in our atmosphere.

It is with these observations in mind, among others, that aspects of the present disclosure were conceived.

### SUMMARY

Provided herein are systems and methods for producing nitrophosphates and mineralized carbon. The systems generally comprise a plasma-nitrogen-fixation system, wherein the plasma-nitrogen fixation system includes a plasma reactor for producing oxidized nitrogen species and an absorber fluidly coupled to the plasma reactor for producing nitric acid from the oxidized nitrogen species; an acidulation reactor fluidly coupled to the absorber for combining the nitric acid produced in the absorber with a phosphate source, thereby producing nitro-phosphoric acid comprising phosphoric acid and calcium nitrate; the acidulation reactor also fluidly coupled to the plasma-nitrogen-fixation system for recycling NOₓ gases produced in the plasma reactor and the acidulation reactor; and a third reactor fluidly coupled to the acidulation reactor for combining the nitrophosphoric acid with ammonia, water, and carbon dioxide, thereby producing a solution comprising nitrophosphates and mineralized carbon. In some embodiments, the mineralized carbon comprises calcium carbonate. In some embodiments, the nitrophosphates comprise diammonium phosphate or monoammonium phosphate. In some embodiments, the carbon dioxide may be diluted in air or may be concentrated carbon dioxide. In some embodiments, the phosphate source comprises phosphate rock.

In some embodiments, the plasma-nitrogen fixation system further comprises an oxidation chamber fluidly coupled to the plasma reactor and to the absorber for further oxidizing partially oxidized nitrogen species produced in the plasma reactor. In some embodiments, the system further comprises a calcination reactor coupled to the acidulation reactor and operable to calcine the phosphate source prior to acidulating the phosphate source and the nitric acid in the acidulation reactor.

In some embodiments, the system further comprises a first separator fluidly coupled to the third reactor for separating the mineralized carbon from the solution. In some embodiments, the first separator comprises a filter.

In some embodiments, the system further comprises a second separator fluidly coupled to the third reactor for separating ammonium carbonate from the solution. In some embodiments, the second separator is a stripper.

In some embodiments, the system further comprises a fourth reactor fluidly coupled to the third reactor for combining the carbon dioxide, water, and ammonia. In some embodiments, the system further comprises a fifth reactor for producing ammonia, the fifth reactor fluidly coupled to the third reactor. In some embodiments, the fifth reactor may be a plasma reactor.

Further provided herein are methods for producing nitrophoshpates and mineralized carbon. The methods generally comprise (a) producing nitric acid in a plasma-nitrogen fixation system; (b) contacting the nitric acid produced in step (a) with a phosphate source in an acidulation reactor to produce nitrophosphoric acid; and (c) combining the nitrophosphoric acid from step (b) with carbon dioxide, water, and ammonia in a third reactor, thereby producing a solution comprising nitrophosphates and mineralized carbon.

In some embodiments, the methods further comprise separating the mineralized carbon from the solution. In some embodiments, the separating is accomplished via a filter. In some embodiments, the methods further comprise separating ammonium carbonate from the solution. In some embodiments, the separating the ammonium carbonate is accomplished via a stripper. In some embodiments, the methods further comprise recycling the ammonium carbonate to the third reactor. In some embodiments, the methods further comprise calcining the phosphate source prior to step (b).

Further provided herein are systems for production of phosphoric acid and calcium nitrate. The systems generally comprise a plasma reactor for producing oxidized nitrogen species; an absorber fluidly coupled to the plasma reactor for producing nitric acid from the oxidized nitrogen species; an acidulation reactor fluidly coupled to the absorber for combining the nitric acid produced in the absorber with a phosphate source, thereby producing nitro-phosphoric acid comprising phosphoric acid and calcium nitrate; and a separator fluidly coupled to the acidulation reactor for separating the phosphoric acid from the calcium nitrate. In some embodiments, the phosphate source comprises phosphate rock. In some embodiments, the system further comprises a calcination reactor coupled to the acidulation reactor and operable to calcine the phosphate source prior to acidulating the phosphate source and the nitric acid in the acidulation reactor. In some embodiments, the acidulation reactor is also fluidly coupled to the absorber for recycling NOₓ gases produced in the plasma reactor and the acidulation reactor.

In some embodiments, the system further comprises an oxidation chamber fluidly coupled to the plasma reactor and to the absorber for further oxidizing partially oxidized nitrogen species produced in the plasma reactor. In some embodiments, the system further comprises a heat exchanger thermally coupled to at least one of the plasma reactor, a calcination reactor, or an acidulation reactor, and to the separator such that waste heat produced by the at least one of the plasma reactor, the calcination reactor, or the acidulation reactor is provided to the separator.

In some embodiments, the system further comprises a separator for separating the phosphoric acid from the calcium nitrate. In some embodiments, the separator comprises a crystallizer for crystalizing the calcium nitrate, a distillation column for removing phosphoric acid.

Further provided herein are methods for producing nitrophosphoric acid. The methods generally comprise (a) producing oxidized nitrogen species in a plasma reactor; (b) contacting the oxidized nitrogen species with water to obtain nitric acid; and (c) contacting the nitric acid produced in step (b) with a phosphate source in an acidulation reactor to produce nitrophosphoric acid. In some embodiments, the nitrophosphoric acid comprises phosphoric acid and calcium nitrate.

In some embodiments, the method further comprises separating the phosphoric acid from the calcium nitrate. In some embodiments, the separating comprises one or more of filtration, crystallization, distillation, and centrifugation. In some aspects, the separating comprises crystallizing the calcium nitrate and distilling the phosphoric acid. In some embodiments, the method further comprises recycling NOₓ gases produced in the acidulation reactor to the plasma reactor.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 shows a block diagram showing an example of a system of the present disclosure for generating nitrophosphoric acid.

FIG. 2 shows a method for generating nitrophosphoric acid.

FIG. 3 shows an exemplary method for generating nitrophosphoric acid.

FIGS. 4A-4D show exemplary systems of the present disclosure for producing nitrophosphate products.

FIG. 5 shows a method for generating nitrohposphate products.

FIG. 6 shows an exemplary method for generating nitrophosphate products.

FIG. 7 shows an exemplary method for generating nitrophosphate products.

### DETAILED DESCRIPTION

Before various aspects of the present invention are disclosed and described, it is to be understood that various aspects of this disclosure are not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

### I. Production of Calcium Nitrate and Phosphoric Acid

Provided herein are systems and methods for the production of phosphoric acid and calcium nitrate. Calcium nitrate is a known fertilizer capable of reducing soil acidity and increasing absorption of minerals in soil. Phosphoric acid is useful in the production of other fertilizer products, as discussed further herein.

The systems of the present disclosure may be powered by electricity to further reduce carbon dioxide release of the systems of the present disclosure. In various possible embodiments, the system is powered by renewable energy sources. Renewable energy sources include, but are not limited to, wind, solar, geothermal, hydroelectric, etc. Preferably, no fossil fuels are consumed by or used to power the system; however, in some implementations non-renewable or a combination of renewable and non-renewable fuels sources may be used.

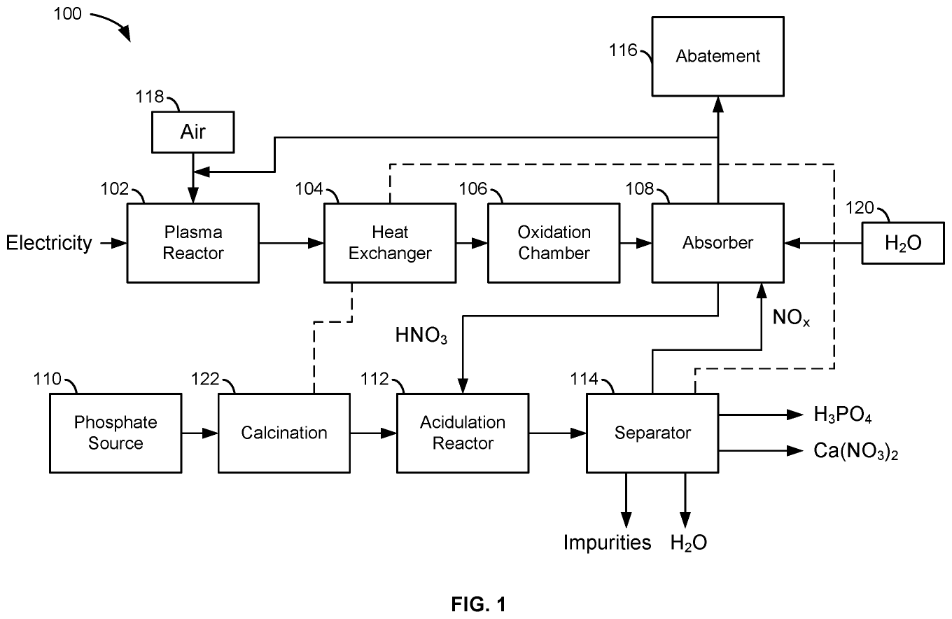

Referring now to FIG. 1, the system 100 comprises a plasma reactor 102. The plasma reactor 102 may comprise a single reactor or it may comprise a system with a plurality of reactors, which may or may not be interconnected in some arrangement such as series or parallel. The reactors may be considered arranged in parallel, with each reactor producing, from the same input streams, the same output streams to the next processing component (or components) in the system. The plasma reactor 102 is operable to receive air and water, which are reacted to form nitric acid. Thus, the plasma reactor 102 may comprise a first inlet stream comprising water and a second inlet stream comprising air. The plasma reactor 102 also comprises an outlet stream comprising oxidized nitrogen species. Non-limiting examples of plasma reactors for use in the system of the present disclosure are described in U.S. patent application Ser. No. 17/240,768 entitled “Systems and processes for producing fixed-nitrogen compounds” filed Apr. 26, 2021, in U.S. patent application Ser. No. 17/970,075 entitled “Durable and serviceable plasma reactor for fertilizer production” filed Oct. 20, 2022, and in U.S. patent application Ser. No. 18/095,736 entitled “Microwave plasma system for efficiently producing nitric acid and nitrogen fertilizers” filed Jan. 11, 2023, the entire contents of each of which are incorporated by reference herein. The plasma reactor 102 is configured to receive a feed stream providing oxygen and nitrogen to the plasma reactor, and to produce a reactor outlet stream including oxidized nitrogen species comprising HNO₃, NO, NO₂, N₂O₄, N₂O, HNO₂, N₂O₅, or a mixture thereof.

The feed stream of the plasma reactor 102 may be fluidly coupled to an air source 118 comprising a blower, a vacuum pump, a compressor, or any other device known in the art capable of supplying air. The air may be purified to reduce the amount of particulate matter or other compounds present in the air before it is introduced to the plasma reactor. In some embodiments, carbon dioxide may be removed from the air to prevent buildup of carbon in the plasma reactor 102. Any removed carbon dioxide may be supplied to other components and operations that process carbon dioxide as discussed herein. In some additional embodiments, the oxygen content of the air may be increased before proceeding to the plasma reactor 102 (e.g., to about 40% to about 60%), which improves the yield of HNO₃. Methods and systems for purifying air are generally known to those having ordinary skill in the art. In some cases, the air source providing the oxygen and nitrogen to the plasma reactor may comprise molecular oxygen to molecular nitrogen in a weight ratio from about 1:1 to about 5:1.

The plasma reactor 102 may be configured to produce a plasma of nitrogen, oxygen, or a combination thereof. In one specific example, the plasma reactor 102 is configured to produce a non-thermal plasma of nitrogen, oxygen, or a mixture thereof. Non-thermal plasma refers to any plasma that is not in thermodynamic equilibrium, e.g., because the ion temperature is different from the electron temperature or because the velocity distribution of one of the species does not follow a Maxwell-Boltzmann distribution. Because the electrons of a non-thermal plasma may have a temperature that is significantly greater (e.g., orders of magnitude greater) than the other species in the reactor, it is believed that the electrons may be used for activating and/or reacting molecular nitrogen and oxygen. In some embodiments, the plasma reactor 102 may be a microwave plasma reactor or a radio frequency (RF) plasma reactor.

The plasma in the plasma reactor 102 may be produced at pressures from about 0 to about 30 bar, preferably from about 0.1 bar to about 5 bar. The gas stream of in the plasma reactor may reach a temperature from about 0 to about 3000° C. In at least one embodiment, the temperature of the body of the plasma reactor 102 is from about 20 to about 500° C. The temperature of the plasma in the plasma reactor may be from about 2000 to about 5000° C. In some embodiments, such as when the plasma reactor is a microwave reactor or a radio frequency plasma reactor, the temperature of the plasma in the plasma reactor may be from about 400° C. to about 1300° C.

In various embodiments, the plasma reactor 102 is powered by renewable energy sources. Renewable energy sources include, but are not limited to, wind, solar, geothermal, hydroelectric, etc. Preferably, no fossil fuels are consumed by or used to power the plasma reactor 102.

The plasma reactor 102 may be thermally coupled to a heat exchanger 104. As described above, the plasma reactor 102 is capable of generating large amounts of heat. The heat exchanger 104 may be thermally coupled to one or more components of the system 100 to provide heat, which would otherwise be waste heat, from the plasma reactor 102. For example, the heat exchanger 104 may be thermally coupled to a separator 114 such as a distillation column. The heat exchanger 104 may be any heat exchanger known in the art, such as a shell and tube heat exchanger, a plate heat exchanger, a plate-fin heat exchanger, an adiabatic wheel heat exchanger, a plate and shell heat exchanger, a pillow plate heat exchanger, etc. The heat exchanger 104 utilizes a heat exchange medium such as water, steam, ethylene glycol, a molten salt, air, or any other heat exchange medium known in the art.

The outlet stream of the plasma reactor 102 may be fluidly coupled to an oxidation chamber 106, where partially oxidized nitrogen species can be converted to further oxidized nitrogen species. The partially oxidized nitrogen species such as NO convert to fully oxidized nitrogen species, such as NO₂, which are readily soluble in water.

The oxidation chamber 106 is fluidly coupled with an absorber 108 containing water to convert the oxidized nitrogen species produced in the plasma reactor 102 to nitric acid (HNO₃). The oxidized nitrogen species that remain in the gas phase may be released from the absorber 108 to a scrubber, or they may be recycled to the feed stream of the plasma reactor 102. Thus, the absorber may be fluidly coupled to the feed stream of the plasma reactor 102. These configurations ensure that no NOₓ gases are released from the system 100 to the environment.

The absorber 108 may be fluidly coupled to a water source 120, such as a tap or other water source. The water provided to the absorber 108 may be purified to prevent scaling in downstream system components and to reduce the number of impurities in the final product. The water may also be purified to control salinity, total dissolved solids, chloride content, hardness, and/or mineral content to meet specific requirements for product purity and agricultural use. Water purification systems useful for these purposes, such as filtration, are generally well-known in the art.

The system 100 further comprises an acidulation reactor 112 for reacting the nitric acid with a phosphate source 110, thereby producing calcium nitrate (Ca(NO₃)₂) and phosphoric acid (H₃PO₄). The acidulation reactor 112 is fluidly coupled to the plasma reactor 102, the oxidation chamber 106, and/or to the absorber 108. The acidulation reactor 112 may include a mechanical agitation system, such as impellers or blades, to ensure thorough mixing. The agitation system may also include a foam breaker to prevent excess foaming during the reaction. The acidulation reactor 112 may have wall baffles to promote a high degree of agitation. The design and power of the agitation system is capable of effectively dispersing the nitric acid throughout the phosphate rock. The acidulation reactor 112 and the mechanical agitation system are made from corrosion-resistant materials, which may be chosen based on the chloride content and/or the fluoride content of the phosphate source. The acidulation reactor 112 may also comprise a cooling jacket to maintain a reaction temperature from about 20-60° C. to prevent excessive corrosion, which may occur at about 75° C. or higher.

Some systems including an acidulation reactor may use concentrated nitric acid as an input due to the lower water content for cost-effective shipping and rapid reactivity. However, lower concentrations of nitric acid may be used in the systems of the present disclosure due to the integration and co-location of nitric acid production with acidulation. In some embodiments, the nitric acid used in the acidulation reactor may have a concentration from about 30 wt % to about 60 wt %, such as from about 30 wt % to about 40 wt %, about 30 wt % to about 50 wt %, about 30 wt % to about 60 wt %, about 40 wt % to about 50 wt %, about 40 wt % to about 60 wt %, or about 50 wt % to about 60 wt %.

In some embodiments, the phosphate source 110 includes phosphate rock. Phosphate rock (also known as rock phosphate) comprises many phosphorus compounds, as will be appreciated by those having ordinary skill in the art. Phosphate rock mainly includes P₂O₅ and calcium oxide (CaO) at a concentration of about 90%, with the balance comprising other oxides such as aluminum oxide (Al₂O₃), iron (Ill) oxide (Fe₂O₃), magnesium oxide (MgO), sodium oxide (Na₂O), and silicon oxide (SiO₂), fluorine, organic carbon, carbonate content, and volatile matter. It is generally mined in large quantities for its phosphate content and is an essential macronutrient for plant growth. Phosphorus compounds present in phosphate rock of particular importance for the system of the present disclosure include calcium phosphate (Ca₃(P₄)₂), and thus phosphate rock that includes calcium phosphate may be used in the systems and methods of the present disclosure. In some embodiments, the phosphate rock may also contain Ca₅(PO₄)₃F and/or Ca₅(PO₄)₃Cl, or similar compounds with F and Cl impurities. In other embodiments, the phosphate source 110 may include aluminum (iron) phosphate and/or calcium aluminum phosphate.

The phosphate rock may include other impurities, such as aluminum, cadmium, chromium, iron, magnesium, sodium, nickel, titanium, zinc, manganese, copper, arsenic, mercury, uranium, vanadium, and organic carbon compounds. Table 1 shows the level of impurities found in phosphoric acid produced from various phosphate sources:

TABLE 1

| Acid from Morocco | | Acid from Geestmerambacht | |
|---|---|---|---|
| Phosphate Rock | | recovered phosphates | |
| Impurity | Concentration (ppm) | Impurity | Concentration (ppm) |
| Al | 200 | Al | 950 |
| Cd | 40 | Cd | <6 |
| Cr | 357 | Cr | 8 |
| Fe | 1600 | Fe | 1260 |
| Mg | 5700 | Mg | 4200 |
| Na | 1700 | Na | 360 |
| Ni | 67 | Ni | 8 |
| Ti | 108 | Ti | 8 |
| Zn | 880 | Zn | 310 |
| Mn | 10 | Mn | 560 |
| Cu | 23 | Cu | 17 |
| As | 5 | As | 2 |
| Organic C | 50 | Organic C | >2000 |

Table 2 shows impurities found in phosphate rock sourced from various countries.

TABLE 2

| | | P₂O₅ | As | Cd | Cr | Hg | U | V |
|---|---|---|---|---|---|---|---|---|
| Country | Deposit | (wt %) | (ppm) | (ppm) | (ppm) | (ppm) | (ppm) | (ppm) |
| Israel | | 32 | 5 | 25 | 227 | 130 | 150 | 200 |
| Jordan | | 32 | 8 | 5 | 92 | 48 | 78 | 70 |
| Morocco | Bu Craa | 35.1 | | 37.5 | | | 75 | |
| | Kouribga | 32.6 | 13.4 | 15.1 | 200 | 855 | 88 | 106 |
| | Yous soufia | 31.2 | 9.2 | 29.2 | 255 | 120 | 97 | 200 |
| Togo | | 36.7 | 10 | 58.4 | 101 | 365 | 94 | 60 |
| USA | Florida | 31.9 | 11.3 | 9.1 | 60 | 199 | 141 | 108 |
| | Idaho | 31.7 | 23.7 | 92.3 | 290 | 107 | 107 | 769 |
| | N. Carolina | 29.9 | 11.2 | 38.2 | 158 | 233 | 65 | 26 |
| South Africa | | 39.5 | 11 | <2 | | | 9 | 17 |
| Tunisia | | 29.3 | 4.5 | 39.5 | 144 | | 44 | 27 |
| Senegal | | 35.9 | 17.4 | 86.7 | 140 | 270 | 67 | 523 |
| Australia | | 28.9 | 14 | 4 | 35 | 75 | 84 | 63 |
| Syria | | 31.9 | 4 | 3 | 105 | 28 | 75 | 140 |
| China | | 31 | 26 | 2.5 | 33 | 4990 | 22.8 | 80 |

When the phosphate rock is mixed with the nitric acid, the phosphate rock acidulates and forms a liquid nitrophosphoric acid solution comprising calcium nitrate (Ca(NO₃)₂) and phosphoric acid (H₃PO₄) according to the reaction below.

Ca₃(PO₄)₂+6HNO₃→2H₃PO₄+3Ca(NO₃)₂

Thus, in various possible embodiments, the phosphate rock and nitric acid may be added in a molar ratio of about 1:6. The phosphate rock and nitric acid may be added in a molar ratio from about 1:4 to about 1:7; for example, about 1:6. The reaction produces heat, which may be captured and provided to other system components in a thermal loop described in more detail below.

Other side-reactions may take place depending on the composition of the phosphate rock. For example, when the phosphate rock contains fluorine, the following side reactions may occur.

Ca₅(PO₄)₃F+10HNO₃→3H₃PO₄+5Ca(NO₃)₂+HF

3Ca₅(PO₄)₃F+H₃PO₄→5Ca₃(PO₄)₂+3HF.

The mixer comprises a first inlet operable to receive the nitric acid from the first reactor and a second inlet operable to receive the phosphate rock. In one example, the phosphate rock may be ground or otherwise milled prior to entry into the mixer to improve the rate of dissolution. Milling the phosphate rock may help to provide greater conversion and require less reaction time. The phosphate rock may be wet-milled to prevent the formation of dust. The acidulation reactor 112 further comprises an outlet operable to deliver the liquid nitrophosphoric acid solution to a separator 114 or other process equipment.

The nitrophosphoric acid may have a pH from about 0 to about 2, or from about 0 to about 1. In some examples, the nitrophosphoric acid may have a pH of about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. Preferably, the nitrophoshporic acid has a pH of less than 1.

In some embodiments, water insoluble byproducts may form in the acidulation reactor 112. For example, calcium hydrogen phosphate (CaHPO₄), magnesium hydrogen phosphate (MgHPO₄), aluminum phosphate (AlPO₄), iron (II) phosphate (FePO₄), and/or calcium fluoride (CaF₂) may form in the acidulation reactor 112. These insoluble impurities may be consumed in a subsequent reactor or may be removed by, for example, a filter, a hydrocyclone separator, an ion-exchange bed, or a settling cone system. In some embodiments, sulfuric acid may be added to the acidulation reactor to produce precipitated gypsum which may retain other impurities and may be removed via filtration.

Fluorine byproducts may also form in the acidulation reactor 112. Rock phosphate may include a small amount of fluorine compounds, which may form hydrofluoric acid (HF) in the mixer. The HF may also react with silicon compounds in the rock phosphate to form hydro-fluoro-silicates and other silicon-based compounds (e.g., silicon tetrafluoride SiF₄). If large amounts of HF are produced by the reaction, equipment primarily made of plastics such as PTFE, LDPE, polypropylene may be used to safely handle the HF. These may be consumed in a second reactor or may be removed by, for example, a filter, a hydrocyclone separator, an ion-exchange bed, or a settling cone system.

In some embodiments, a calcination reactor 122 may be positioned for pretreatment of the phosphate source. The calcination reactor 122 is operably connected to the phosphate source 110 and to the acidulation reactor 112, such that the calcined phosphate source may be transferred from the calcination reactor 122 to the acidulation reactor 112. This pretreatment will take place in a reactor configured to reach temperatures of 1100° C. or greater. When the phosphate source comprises phosphate rock, and in particular phosphate rock that includes Ca₅(PO₄)₃F, the calcination reaction removes some volatilized impurities from the rock, such as fluorine and chlorine. In particular, the removal of fluorine at this step may mitigate the presence of HF that would otherwise form in the acidulation reactor 112. Further, with the integration of the plasma reactor 102 and heat exchanger 104, waste heat from the plasma reactor 102 may be used to perform the calcination reaction, thereby preparing the phosphate source for acidulation. Calcination of phosphate rock also increases the phosphorous content and increases its solubility in acidic solutions, which allows for lower grades of phosphate rock to be used and/or for lower concentrations of nitric acid to be used, both of which lower the cost of this integrated process.

The calcination reaction may be accomplished by introducing silica or a dilute acid, such as citric acid or—as is advantageous here—nitric acid to the calcination reactor 122 while heating the contents to a temperature of about 1100° C. or greater in the presence of steam. The fluorine in the Ca₅(PO₄)₃F is removed, leaving Ca₃(PO₄)₂. In some embodiments, the temperature may be increased to about 1400° C. or greater to promote the formation of the alpha-Ca₃(PO₄)₂ polymorph, which is generally more soluble in acid than beta-Ca₃(PO₄)₂ polymorph. In some embodiments, sodium carbonate may also be added to the calcination reactor 122. The sodium carbonate effectively removes fluorine from the phosphate source by reacting to produce NaF and CaNaPO₄.

Further byproducts may include gaseous nitrogen oxides (NOₓ), which may be recycled to the plasma reactor 102 or to the absorber 108, to a second absorber fluidly connected to the plasma reactor solely for recycle of the NOₓ gases, or a combination thereof. This is a major advantage of the integration of the nitric acid and phosphoric acid production systems, as it allows additional product to be captured which would otherwise be wasted. In systems utilizing a calcination reactor 124, the NOx gases are not contaminated with HF. Alternatively or additionally, remaining NOx may be passed through an abatement system 116 before gaseous release to atmosphere. The abatement system 116 may comprise a scrubber to react with the NOₓ to form acids or other nitrate species, a catalytic scrubber to reduce the NOₓ to N₂ gas, or a solid adsorption media to adsorb the NOₓ.

The phosphoric acid and calcium nitrate may be separated from the nitrophosphoric acid in separator 114. The separator 114 may be a single separation process unit or separator 114 may comprise a plurality of separation process units connected in parallel or in series. The separator 114 may be configured to separate via filtration, crystallization, distillation, centrifugation, solvent extraction, evaporation, or other industrial separation methods and combinations thereof. Additionally, water and other impurities may be removed in the separator 114. In some embodiments, waste heat from the plasma reactor 102 may be used to evaporate water from the phosphoric acid and calcium nitrate in separator 114. In some embodiments, the separator 114 comprises a crystallizer for crystallizing the calcium nitrate and a distillation column for separating phosphoric acid.

In some embodiments, ammonia may be added to the mixture of the phosphoric acid and calcium nitrate prior to entering the separator 114 to form calcium ammonium nitrate. This configuration is especially preferable when the separator 114 is configured to separate via crystallization.

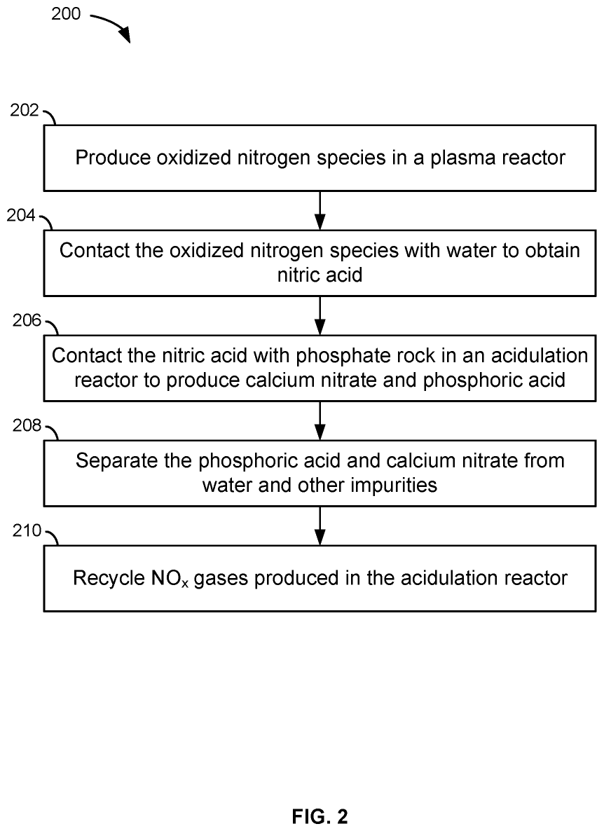

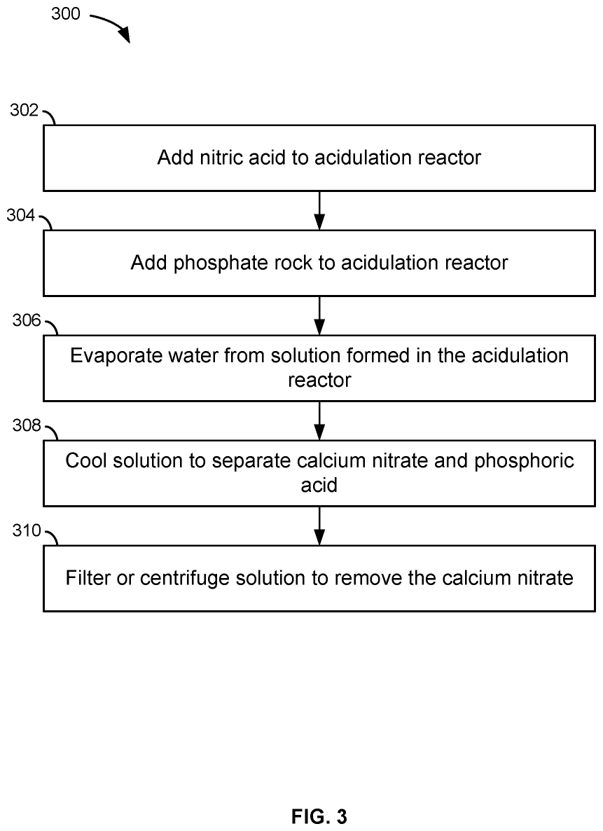

Further provided herein are methods for producing phosphoric acid and calcium nitrate. Referring now to FIG. 2, the method 200 commences at step 202 by producing oxidized nitrogen species in a plasma reactor. The plasma reactor may be any plasma reactor discussed hereinabove operable to produce oxidized nitrogen species.

Next at step 204, the method 200 comprises contacting the oxidized nitrogen species with water in an absorber to obtain nitric acid. In some embodiments, the oxidized nitrogen species may be further oxidized in an oxidation chamber prior to step 204 to fully oxidize any partially oxidized nitrogen species and to increase the yield of nitric acid. The absorber and the oxidation chamber may be any absorber or oxidation chamber described hereinabove.

Next at step 206, the method 200 comprises contacting the nitric acid with a phosphate source in an acidulation reactor to produce calcium nitrate and phosphoric acid. The acidulation reactor may be any acidulation reactor described herein. The nitric acid may be mixed with the phosphate source at a ratio of about 6:1 (nitric acid:phosphate source) on a mol basis. In particular, when the phosphate source comprises calcium phosphate, the nitric acid may be mixed with the phosphate source at a ratio of about 6:1 (nitric acid:phosphate source) on a mol basis. The nitric acid may also be mixed with the phosphate source at a ratio of about 5:1 to about 7:1 (nitric acid:phosphate source) on a mol basis. In some embodiments, phosphoric acid may be added to during this step to control the ratio of nitrogen to phosphate in the acidulation reactor.

Next at step 208, the method 200 comprises separating the acidulated species produced in step 206 from water and other impurities. The method 200 may also comprise separating the phosphoric acid from the calcium nitrate. These steps may be performed using a separator described hereinabove with respect to FIG. 1.

Next at step 210, the method 200 comprises recycling NOₓ gases produced in the acidulation reactor and recycling them to the plasma reactor. This prevents release of the NOₓ gases to the atmosphere and allows them to become fully oxidized for use in producing additional nitric acid.

The method may further comprise calcining the phosphate source in a calcination reactor. This step is done prior to contacting the phosphate source with the nitric acid in the acidulation reactor. This optional step includes heating the phosphate source and one of silica or a dilute acid in a calcination reactor in the presence of steam. The temperature at which the calcination step is performed may be about 1100° C. or greater, or more preferably at about 1400° C. or greater.

In an exemplary method 300, in step 302, nitric acid is added to the acidulation reactor. In step 304, phosphate rock with 600 μm particle size is fed to the acidulation reactor in an appropriate ratio to the nitric acid as described above. A static mixer may be used for a more complete and uniform reaction. Upon complete addition of the phosphate rock, a minimal amount of foaming may be observed. The temperature of the solution may be controlled between 20° C. and 70° C. The product may be filtered after the time period in the solution is complete to remove the insoluble impurities. In step 306 after the time period in the solution is complete, the solution may be dried to evaporate the water. In step 308, the solution may be cooled down to separate the calcium nitrate and phosphoric acid. In step 310, the separated solution may be filtered or centrifuged at 10000 rpm for 20 minutes. The reaction duration may change for complete acidulation depending on the acid concentration, rock particle size, rock impurities, and agitation.

### II. Production of Nitrophosphates and Mineralized Carbon

Further provided herein are systems and methods for the production of nitrophosphates and mineralized carbon. The systems of the present disclosure may have the distinct advantage of having no fossil fuel inputs and employing carbon sequestration, while still producing valuable end-use products such as fertilizers for consumers. In particular, the systems of the present disclosure can be used as a form of direct air capture technology, whereby carbon dioxide from the air reacts and the carbon is sequestered while allowing the other components in the air to pass through unreacted. The systems may be configured for continuous operation or for batch operation. Therefore, in some implementations, the systems and methods of the present disclosure include no carbon-based feedstocks other than carbon dioxide. The systems and methods described in this section comprise the systems described in Section I above, using the produced phosphoric acid and calcium nitrate as feedstocks.

The systems of the present disclosure may be powered by electricity to further reduce carbon dioxide release of the systems of the present disclosure. In various possible embodiments, the system is powered by renewable energy sources. Renewable energy sources include, but are not limited to, wind, solar, geothermal, hydroelectric, etc. Preferably, no fossil fuels are consumed by or used to power the system; however, in some implementation non-renewable or a combination of renewable and non-renewable fuels sources may be used.

Referring again to FIG. 1, the system 100 comprises a plasma reactor 102. The plasma reactor 102 may comprise a single reactor or it may comprise a system with a plurality of reactors, which may or may not be interconnected in some arrangement such as series or parallel. The reactors may be considered arranged in parallel, with each reactor producing, from the same input streams, the same output streams to the next processing component (or components) in the system. The plasma reactor 102 is operable to receive air and water, which are reacted to form nitric acid. Thus, the plasma reactor 102 may comprise a first inlet stream comprising water and a second inlet stream comprising air. The plasma reactor 102 also comprises an outlet stream comprising oxidized nitrogen species. Non-limiting examples of plasma reactors for use in the system of the present disclosure are described in U.S. patent application Ser. No. 17/240,768 entitled “Systems and processes for producing fixed-nitrogen compounds” filed Apr. 26, 2021, and in U.S. patent application Ser. No. 17/970,075 entitled “Durable and serviceable plasma reactor for fertilizer production” filed Oct. 20, 2022, the entire contents of each of which are incorporated by reference herein. The plasma reactor 102 is configured to receive a feed stream providing oxygen and nitrogen to the plasma reactor, and to produce a reactor outlet stream including oxidized nitrogen species comprising HNO₃, NO, NO₂, N₂O₄, N₂O, HNO₂, N₂O₅, or a mixture thereof.

The feed stream of the plasma reactor 102 may be fluidly coupled to an air source 118 comprising a blower, a vacuum pump, a compressor, or any other device known in the art capable of supplying air. The air may be purified to reduce the amount of particulate matter or other compounds present in the air before it is introduced to the plasma reactor. In some embodiments, carbon dioxide may be removed from the air to prevent buildup of carbon in the plasma reactor 102. Any removed carbon dioxide may be supplied to other components and operations that process carbon dioxide as discussed herein. In some additional embodiments, the oxygen content of the air may be increased before proceeding to the plasma reactor 102 (e.g., to about 50%), which improves the yield of HNO₃. Methods and systems for purifying air are generally known to those having ordinary skill in the art. In some cases, the air source providing the oxygen and nitrogen to the plasma reactor may comprise molecular oxygen to molecular nitrogen in a weight ratio from about 1:1 to about 5:1.

The plasma reactor 102 may be configured to produce a plasma of nitrogen, oxygen, or a combination thereof. In one specific example, the plasma reactor 102 is configured to produce a non-thermal plasma of nitrogen, oxygen, or a mixture thereof. Non-thermal plasma refers to any plasma that is not in thermodynamic equilibrium, e.g., because the ion temperature is different from the electron temperature or because the velocity distribution of one of the species does not follow a Maxwell-Boltzmann distribution. Because the electrons of a non-thermal plasma may have a temperature that is significantly greater (e.g., orders of magnitude greater) than the other species in the reactor, it is believed that the electrons may be used for activating and/or reacting molecular nitrogen and oxygen. In some embodiments, the plasma reactor 102 may be a microwave plasma reactor or a radio frequency (RF) plasma reactor.

The plasma in the plasma reactor 102 may be produced at pressures from about 0 to about 30 bar, preferably from about 0.1 bar to about 5 bar. The gas stream of in the plasma reactor may reach a temperature from about 0 to about 3000° C. In at least one embodiment, the temperature of the body of the plasma reactor 102 is from about 20 to about 500° C. The temperature of the plasma in the plasma reactor may be from about 2000 to about 5000° C. In some embodiments, such as when the plasma reactor is a microwave reactor or a radio frequency plasma reactor, the temperature of the plasma in the plasma reactor may be from about 400° C. to about 1300° C.

In various embodiments, the plasma reactor 102 is powered by renewable energy sources. Renewable energy sources include, but are not limited to, wind, solar, geothermal, hydroelectric, etc. Preferably, no fossil fuels are consumed by or used to power the plasma reactor 102.

The plasma reactor 102 may be thermally coupled to a heat exchanger 104. As described above, the plasma reactor 102 is capable of generating large amounts of heat. The heat exchanger 104 may be thermally coupled to one or more components of the system 100 to provide heat, which would otherwise be waste heat from the plasma reactor 102. For example, the heat exchanger 104 may be thermally coupled to a separator 114 such as a distillation column. The heat exchanger 104 may be any heat exchanger known in the art, such as a shell and tube heat exchanger, a plate heat exchanger, a plate-fin heat exchanger, an adiabatic wheel heat exchanger, a plate and shell heat exchanger, a pillow plate heat exchanger, etc. The heat exchanger 104 utilizes a heat exchange medium such as water, ethylene glycol, a molten salt, or any other heat exchange medium known in the art.

The outlet stream of the plasma reactor 102 may be fluidly coupled to an oxidation chamber 106, where partially oxidized nitrogen species can be converted to further oxidized nitrogen species. The partially oxidized nitrogen species such as NO convert to fully oxidized nitrogen species such as NO₂, which are readily soluble in water.

The oxidation chamber 106 is fluidly coupled with an absorber 108 containing water to convert the oxidized nitrogen species produced in the plasma reactor 102 to nitric acid (HNO₃). The oxidized nitrogen species that remain in the gas phase may be released from the absorber 108 to a scrubber, or they may be recycled to the feed stream of the plasma reactor 102. Thus, the absorber may be fluidly coupled to the feed stream of the plasma reactor 102. These configurations ensure that no NOₓ gases are released from the system 100 to the environment.

The absorber 108 may be fluidly coupled to a water source 120, such as a tap water or other water source. The water provided to the absorber 108 may be purified to prevent scaling in downstream system components and to reduce the number of impurities in the final product. The water may also be purified to control salinity, total dissolved solids, chloride content, hardness, and/or mineral content to meet specific requirements for product purity and agricultural use. Water purification systems useful for these purposes, such as filtration, are generally well-known in the art.

The plasma reactor 102, the oxidation chamber 106, and the absorber 108 may be collectively referred to as a “plasma-nitrogen-fixation system”.

The system 100 further comprises an acidulation reactor 112 for reacting the nitric acid with a phosphate source 110, thereby producing calcium nitrate (Ca(NO₃)₂) and phosphoric acid (H₃PO₄). The acidulation reactor 112 is fluidly coupled to the plasma reactor 102, the oxidation chamber 106, and/or to the absorber 108. The acidulation reactor 112 may include a mechanical agitation system, such as impellers or blades, to ensure thorough mixing. The agitation system may also include a foam breaker to prevent excess foaming during the reaction. The acidulation reactor 112 may have wall baffles to promote a high degree of agitation. The design and power of the agitation system is capable of effectively dispersing the nitric acid throughout the phosphate rock. The acidulation reactor 112 and the mechanical agitation system are made from corrosion-resistant materials, which may be chosen based on the chloride content and/or the fluoride content of the phosphate source. The acidulation reactor 112 may also comprise a cooling jacket to maintain a reaction temperature from about 20-60° C. to prevent excessive corrosion, which may occur at about 75° C. or higher.

In some embodiments, the phosphate source 110 includes phosphate rock. Phosphate rock (also known as rock phosphate) comprises many phosphorus compounds, as will be appreciated by those having ordinary skill in the art. In particular, phosphate rock mainly includes P₂O₅ and calcium oxide (CaO) at a concentration of about 90%, with the balance comprising other oxides such as aluminum oxide (Al₂O₃), iron (Ill) oxide (Fe₂O₃), magnesium oxide (MgO), sodium oxide (Na₂O), and silicon oxide (SiO₂), fluorine, organic carbon, carbonate content, and volatile matter. It is generally mined in large quantities for its phosphate content and is an essential macronutrient for plant growth. Phosphorus compounds of particular importance for the system of the present disclosure include calcium phosphate (Ca₃(PO₄)₂). In other embodiments, the phosphate source 110 may include aluminum (iron) phosphate and/or calcium aluminum phosphate.

The phosphate rock may include impurities, such as aluminum, cadmium, chromium, iron, magnesium, sodium, nickel, titanium, zinc, manganese, copper, arsenic, mercury, uranium, vanadium, and organic carbon compounds. Examples of these impurities are provided in Table 1 above.

When the phosphate rock is mixed with the nitric acid, the phosphate rock acidulates and forms a liquid nitrophosphoric acid solution comprising calcium nitrate (Ca(NO₃)₂) and phosphoric acid (H₃PO₄) according to the reaction below.

Ca₃(PO₄)₂+6HNO₃→2H₃PO₄+3Ca(NO₃)₂

Thus, in various possible embodiments, the phosphate rock and nitric acid may be added in a molar ratio of about 1:6. The phosphate rock and nitric acid may be added in a molar ratio from about 1:4 to about 1:7; for example, about 1:6.

Other side-reactions may take place depending on the composition of the phosphate rock. For example, when the phosphate rock contains fluorine, the following side reactions may occur.

Ca₅(PO₄)₃F+10HNO₃→3H₃PO₄+5Ca(NO₃)₂+HF

3Ca₅(PO₄)₃F+H₃PO₄→5Ca₃(PO₄)₂+3HF.

The mixer comprises a first inlet operable to receive the nitric acid from the first reactor and a second inlet operable to receive the phosphate rock. In one example, the phosphate rock may be ground or otherwise milled prior to entry into the mixer to improve the rate of dissolution. Milling the phosphate rock may help to provide greater conversion and require less reaction time. The phosphate rock may be wet-milled to prevent the formation of dust. The acidulation reactor 112 further comprises an outlet operable to deliver the liquid nitrophosphoric acid solution to a separator or other process equipment.

The nitrophosphoric acid may have a pH from about 0 to about 2, or from about 0 to about 1. In some examples, the nitrophosphoric acid may have a pH of about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. Preferably, the nitrophoshporic acid has a pH of less than 1.

In some embodiments, water insoluble byproducts may form in the acidulation reactor 112. For example, calcium hydrogen phosphate (CaHPO₄), magnesium hydrogen phosphate (MgHPO₄), aluminum phosphate (AlPO₄), iron (II) phosphate (FePO₄), and/or calcium fluoride (CaF₂) may form in the acidulation reactor 112. These insoluble impurities may be consumed in a subsequent reactor or may be removed by, for example, a filter, a hydrocyclone separator, an ion-exchange bed, or a settling cone system. In some embodiments, sulfuric acid may be added to the acidulation reactor to produce precipitated gypsum which may retain other impurities and may be removed via filtration.

Fluorine byproducts may also form in the acidulation reactor 112. Rock phosphate may include a small amount of fluorine compounds, which may form hydrofluoric acid (HF) in the mixer. The HF may also react with silicon compounds in the rock phosphate to form hydro-fluoro-silicates and other silicon-based compounds (e.g., silicon tetrafluoride SiF₄). If large amounts of HF are produced by the reaction, equipment primarily made of plastics such as PTFE, LDPE, polypropylene may be used to safely handle the HF. These may be consumed in the second reactor or may be removed by, for example, a filter, a hydrocyclone separator, an ion-exchange bed, or a settling cone system.

Further byproducts may include gaseous nitrogen oxides (NOₓ), which may be recycled to the plasma reactor 102 or to the absorber 108, to a second absorber fluidly connected to the plasma reactor solely for recycle of the NOₓ gases, or a combination thereof. This is a major advantage of the integration of the nitric acid and phosphoric acid production systems, as it allows additional product to be captured which would otherwise be wasted. Alternatively or additionally, remaining NOx may be passed through an abatement system 116 before gaseous release to atmosphere. The abatement system 116 may comprise a scrubber to react with the NOₓ to form acids or other nitrate species, a catalytic scrubber to reduce the NOₓ to N₂ gas, or a solid adsorption media to adsorb the NOₓ.

The phosphoric acid and calcium nitrate may be separated from the nitrophosphoric acid in separator 114. The separator 114 may be configured to separate via filtration, crystallization, distillation, centrifugation, or other industrial separation methods. Additionally, water and other impurities may be removed in the separator 114. In some embodiments, waste heat from the plasma reactor 102 may be used to evaporate water from the phosphoric acid and calcium nitrate. In some embodiments, the separator 114 comprises a crystallizer for crystallizing the calcium nitrate and a distillation column for separating phosphoric acid.

In some embodiments, ammonia may be added to the mixture of the phosphoric acid and calcium nitrate prior to entering the separator 114 to form calcium ammonium nitrate. This configuration is especially preferable when the separator 114 is configured to separate via crystallization.

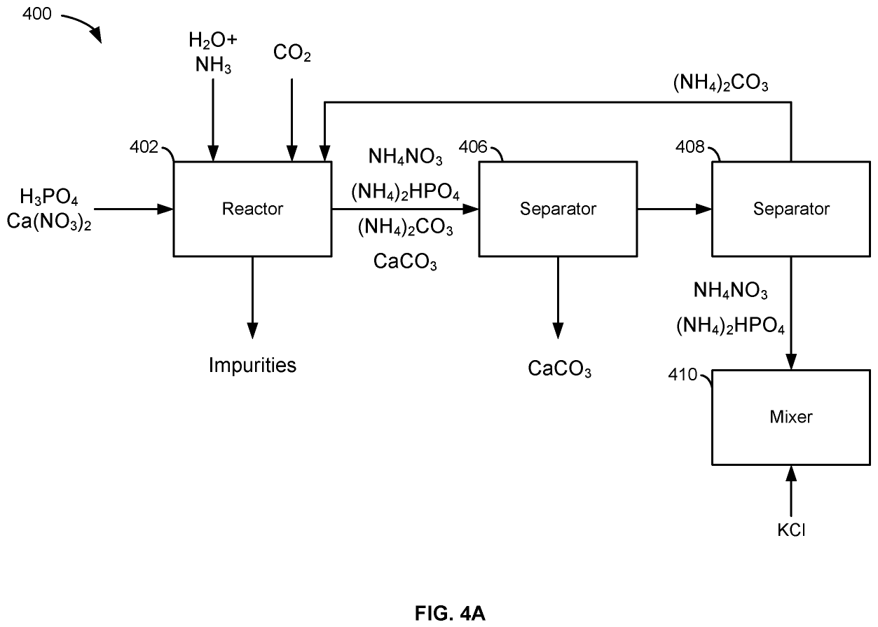

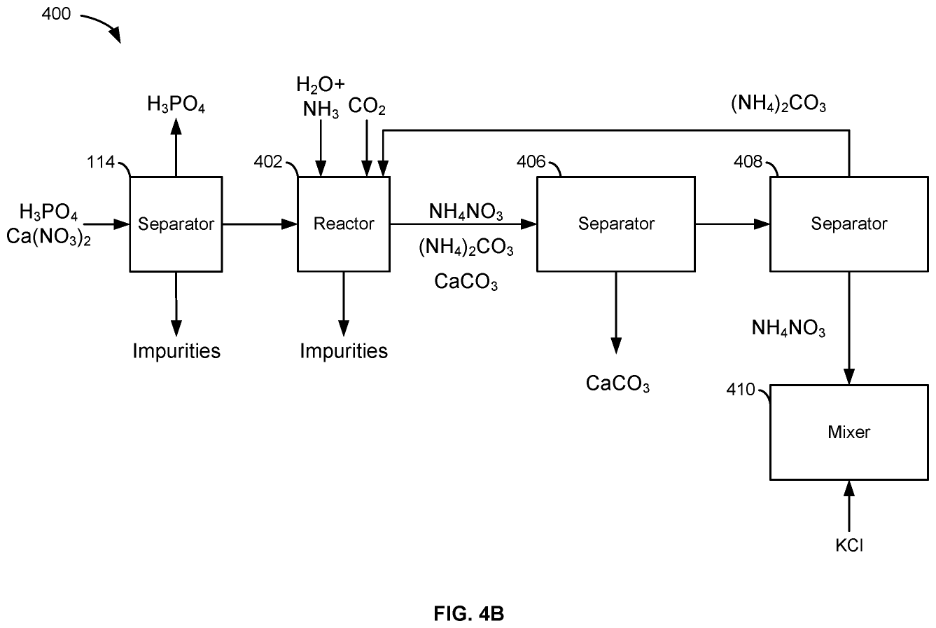

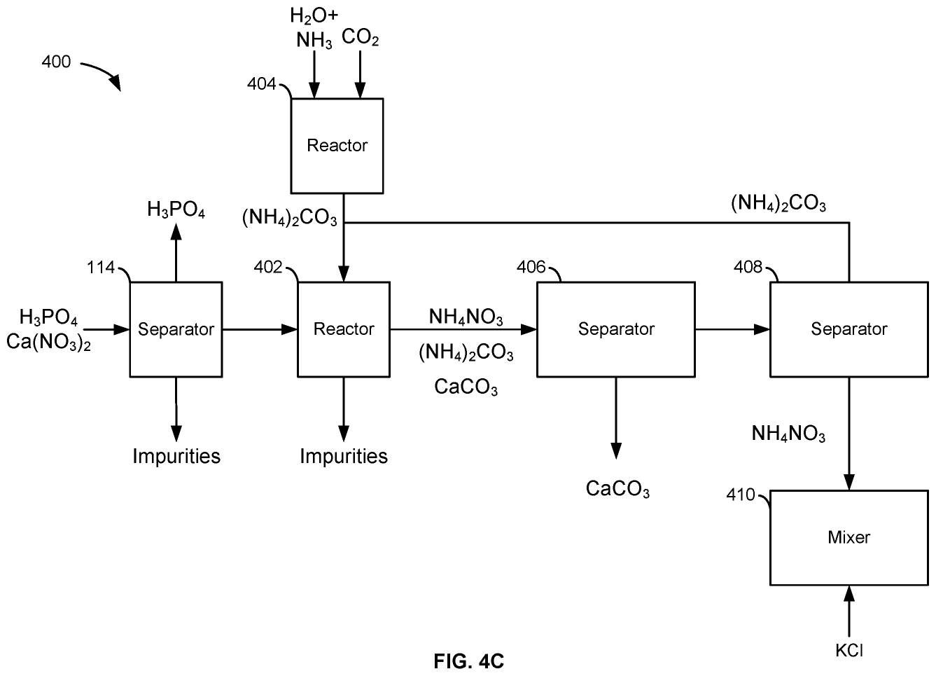

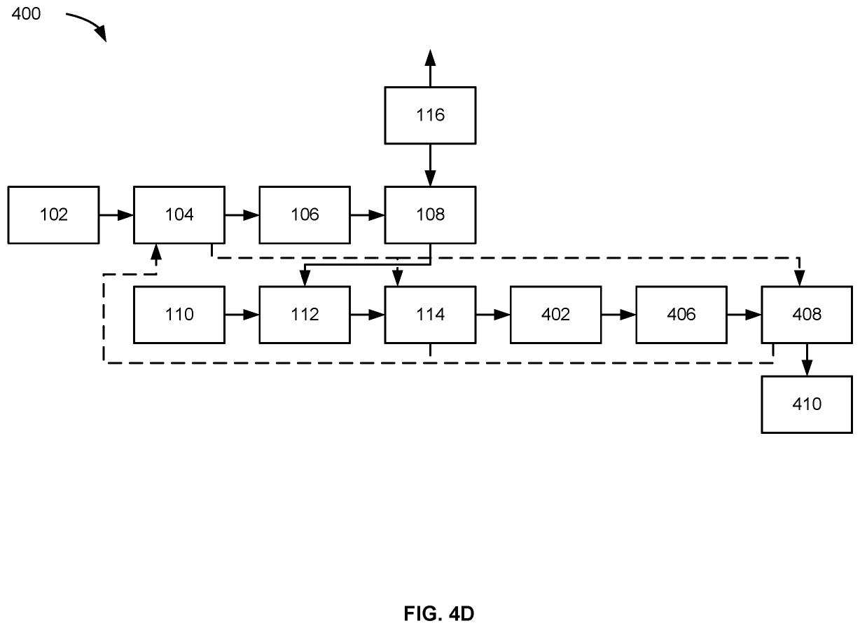

Referring now to FIGS. 4A-4D, the system 400 further comprises a third reactor 402. The third reactor may comprise a single reactor or a plurality of reactors, which may be deployed in the system in various possible arrangements including in parallel where the reactors each have the same inputs and produce the same outputs for the next device in the system, and may also be deployed in the system in what would be considered in parallel or in series. The third reactor may receive and further process the output from the acidulation reactor. In one example, the third reactor 402 may be fluidly coupled to the acidulation reactor (as illustrated in FIG. 1 but not shown in the various FIG. 4) and is operable to receive the nitrophosphoric acid solution from the acidulation reactor. It will be appreciated by those having ordinary skill in the art that the reactions described herein as being performed in the third reactor may alternatively be performed in the acidulation reactor, therefore eliminating the need for an additional reactor in the system. In other words, the acidulation reactor and the third reactor may be combined into a single reactor.

The third reactor 402 may also be operable to receive carbon dioxide, as shown in FIG. 4A. The third reactor may thus be fluidly coupled to a carbon dioxide source, which may be a natural source such as from air, and may involve a fan, blower, vacuum pump, or may be from a carbon dioxide storage tank, etc. The carbon dioxide received by the third reactor may be diluted in air, or it may be concentrated. In some embodiments, the carbon dioxide is provided at a concentration in air from about 400 ppm to about 99 mol %; for example, 400 ppm, 500 ppm, 750 ppm, 1000 ppm, 1%, 5%, 10%, 25%, 50%, 75%, 90%, or 99%. In some embodiments, the carbon dioxide may be provided at a concentration in air of less than 400 ppm, such as 300 ppm or less, 200 ppm or less, or 100 ppm or less.

The third reactor 402 is also operable to receive ammonia and water. The ammonia may be provided as gaseous ammonia, liquid ammonia, or ammonium hydroxide. When all of the reactants are mixed, they react to form nitrophosphates and mineralized carbon. Nitrophosphates formed in the third reactor 402 may have a molar ratio of nitrogen to P₂O₅ from about 1:1 to about 4:1. Generally, the nitrophosphates may include ammonium phosphate, monoammonium phosphate, diammonium phosphate, triammonium phosphate, calcium nitrate, phosphoric acid, and/or ammonium nitrate. In some embodiments, the nitrophosphates comprise monoammonium phosphate or diammonium phosphate. The mineralized carbonate species formed in the third reactor 402 may include calcium carbonate, magnesium carbonate, sodium carbonate, potassium carbonate, calcium bicarbonate, magnesium bicarbonate, sodium bicarbonate, and/or potassium bicarbonate. Generally, the mineralized carbon comprises calcium carbonate, as shown in FIG. 4A.

In a non-limiting embodiment, the nitrophosphates and mineralized carbon are formed according to the following reactions.

2H₃PO₄+2NH₃→2[(NH₄)₂H₂PO₄]

3Ca(NO₃)₂+6NH₃+3CO₂+3H₂O→6(NH₄)NO₃+3CaCO₃

The overall reaction scheme for the plasma reactor (not shown in FIG. 4A) and the third reactor 402 may therefore be summarized as shown below. As can be seen, for approximately every mol of calcium phosphate inputted, approximately three mols of carbon dioxide are sequestered.

Ca₃(PO₄)₂+6HNO₃+8 NH₃+3 CO₂+3 H₂O→2[(NH₄)₂H₂PO₄]+6(NH₄)NO₃+3 Ca(CO₃)

In some embodiments, as shown in FIG. 4B, the phosphoric acid may be separated from the nitrophosphoric acid solution in a separator 114 prior to entering the third reactor 402. In this case, only the calcium nitrate reacts with the ammonia, carbon dioxide, and water to form ammonium nitrate and calcium carbonate, as shown in the reaction below.

3Ca(NO₃)₂+6NH₃+3CO₂+3H₂O→6(NH₄)NO₃+3CaCO₃

The separator 114 may be configured to separate via filtration, crystallization, distillation, centrifugation, or other industrial separation methods. Additionally, water and other impurities may be removed in the separator 114. In embodiments where ammonium is added to the phosphoric acid and calcium nitrate before entering the separator 114, the molar amount of ammonia added in the reaction above may be reduced.

In some embodiments, as shown in FIG. 4C, the carbon dioxide, water, and ammonia may be combined in a fourth reactor 404 prior to combining them in the third reactor 402. The fourth reactor 404 may comprise a single reactor or a plurality of reactors. In some embodiments, the fourth reactor 404 may comprise a continuously stirred tank reactor or a packed bed tower. The fourth reactor 404 may comprise mechanical agitation and mixing systems to thoroughly mix the contents of the reactor. The fourth reactor 404 may further comprise a cooling system to control the heat of the reaction. The fourth reactor 404 may react the carbon dioxide, water, and ammonia to form ammonium carbonate according to the following reaction:

2NH₃+CO₂+H₂O→(NH₄)₂CO₃

In such embodiments, the ammonium carbonate and any unreacted ammonia, carbon dioxide, and water would be provided to the third reactor 402 for reacting with the nitrophosphoric acid solution.

A byproduct of the reaction(s) taking place in the third reactor 402 may include ammonium carbonate ((NH₄)₂CO₃). The ammonium carbonate may be recycled after being separated in a second separator 408, as described in more detail below. The recycled ammonium carbonate may be added to the third reactor 402, where it may react with the phosphoric acid and the calcium nitrate according to the reaction below to form additional mineralized carbon, nitrophosphates, and additional CO₂. As will be appreciated by those having ordinary skill in the art, the additional CO₂ generated by this reaction will react with the ammonia and the calcium nitrate according to the reaction shown above to further produce mineralized carbon such as calcium carbonate.

The total conversion of the acidulation effluent (i.e., the effluent from the acidulation reactor) may be achieved when the molar ratio of the carbon dioxide to the H₃PO₄ is greater than about 7; for example, greater than about 7, greater than about 8, greater than about 9, greater than about 10, greater than about 11, greater than about 12, greater than about 13, greater than about 14, or greater than about 15.

Additional byproducts produced in the second reactor may include magnesium, cobalt, copper, iron, manganese, molybdenum, nickel, zinc, fluorine, arsenic, aluminum, mercury, lead, and/or cadmium, and oxides, carbonates, bicarbonates, nitrates, and phosphates thereof. These byproducts may be removed via the first separator 403, or they may be included in a fertilizer product.

The acidulation reactor and/or the third reactor 402 may also be operable to receive an anti-foaming agent. If too much foam is produced in the third reactor 402, it may be difficult to achieve high rates of conversion with low concentrations of carbon dioxide. Anti-foaming agents also may prevent foaming caused by decomposition of ammonium carbonate formed in or recycled to the third reactor 402. Antifoaming agents that may be useful in the systems of the present disclosure include silicone-based antifoaming agents, mineral oil-based antifoaming agents, and water-based antifoaming agents. A non-limiting example of an antifoaming agent suitable for use in the present disclosure includes silicone oils (e.g., polydimethylsiloxane or modified siloxanes) often with hydrophobic silica dispersed in solution. As will be appreciated by those having skill in the art, the addition rate, temperature, decomposition of organic matter or carbonates by rock calcination, and other factors can affect the extent of foaming formation. Anti-foaming agents are generally known in the art, and include oil-based anti-foaming agents, water-based anti-foaming agents, and silicone-based anti-foaming agents.

In various possible embodiments, the third reactor 402 and/or the fourth reactor 404 is powered by renewable energy sources. Renewable energy sources include, but are not limited to, wind, solar, geothermal, hydroelectric, etc. Preferably, no fossil fuels are consumed by or used to power the third reactor.

The system 400 further comprises a first separator 406 to separate mineralized carbon from the solution produced by the third reactor 402. The first separator 406 may comprise a single separator or a plurality of separators connected in series or in parallel. The first separator 406 may comprise any separator useful for separating solids precipitated in a liquid. In one embodiment, the first separator comprises a filter. Filters and methods for making, procuring, and sizing filters are generally known to those having ordinary skill in the art.

The mineralized carbon may be set aside for permanent storage on land or in the ocean. A small concentration (i.e., less than 1 wt %) of phosphate and/or ammonium compounds may be present in the mineralized carbon.

The system 400 may be operable to sequester about 1.5 to about 4.0 tons per day of carbon for every ton per day of fixed nitrogen used. For example, the system may be operable to sequester about 1.5 to about 2.0 about 1.5 to about 2.5, about 1.5 to about 3.0, about 1.5 to about 3.5, about 1.5 to about 4.0, about 2.0 to about 4.0, about 2.5 to about 4.0, about 3.0 to about 4.0, about 3.5 to about 4.0, about 2.0 to about 3.5, or about 2.0 to about 3.0 tons per day of carbon for every ton per day of fixed nitrogen used.

The system 400 further comprises a second separator 408 to separate the ammonium carbonate from the solution produced by the third reactor 402. The second separator 408 may comprise a single separator or a plurality of separators connected in series or in parallel. The second separator 408 may comprise any separator useful for separating dissolved components of a solution. In one example, the second separator comprises a stripper. Strippers and methods for making, procuring, and sizing strippers are generally known to those having ordinary skill in the art. In some embodiments, the stripper heats the solution from the first separator 406 to a temperature ranging from about 150° F. to about 300° F. Preferably, the heat is provided at least in part by heat produced by the plasma reactor. Thus, the second separator 408 may be thermally coupled to the plasma reactor via one or more heat exchangers.

The system may further comprise a fifth reactor. The fifth reactor may comprise a single reactor or it may comprise a plurality of reactors connected in series or in parallel. The fifth reactor may be operable to produce ammonia either through a chemical process (e.g., the Haber Bosch process) or through an electrochemical process. The fifth reactor may be fluidly coupled with the third reactor 402 to provide the ammonia to the third reactor 402. In one example, the fifth reactor is a plasma reactor.

The system 400 may further comprise a mixer 410. The mixer 410 is operable to mix the solution comprising nitrophosphates with a potassium compound. This mixture may be suitable as a NPK fertilizer (nitrogen-phosphorus-potassium). Potassium is an important element in fertilizer, as will be appreciated by those having ordinary skill in the art. The potassium compound may include potassium chloride (KCl), potassium sulfate (K₂SO₄), and/or potassium nitrate (KNO₃). The mixer 410 may include a first inlet fluidly coupled to the third reactor 402, the first separator 406, or the second separator 408 to receive the solution comprising nitrophosphates and a second inlet operable to receive the potassium compound. The mixer 410 may include an outlet operable to deliver the mixture of nitrophosphates and potassium. The mixture is preferably used as fertilizer or to produce a fertilizer.

The system may further comprise a recycle loop. As shown in FIGS. 4A-4C, a recycle loop may be formed between the second separator 408 and the third reactor 402, whereby ammonium carbonate collected by the second separator 408 is recycled to the third reactor 402.

The system 400 may further comprise a thermal loop. As shown in FIG. 4D, the thermal loop allows for thermal communication between the plasma reactor 102 and the second separator 408. When the second separator 408 is a stripper, the thermal loop is operable to provide heat to the vapor phase. The thermal loop may include one or more heat exchangers operable to transfer heat between the first reactor and the second separator. The one or more heat exchangers may include shell and tube heat exchangers, plate heat exchangers, plate and shell heat exchangers, adiabatic wheel heat exchangers, plate fin heat exchangers, finned tube heat exchangers, pillow plate heat exchangers, and other heat exchangers known to those having ordinary skill in the art.

The thermal loop may also allow for thermal communication with other system components, including the acidulation reactor 112, the separator 114, a calcination reactor 124, the third reactor 402, the fourth reactor 404, the fifth reactor, etc. Particularly advantageous to system integration, the thermal loop may be operable to use the waste heat from the plasma reactor 102 for to provide heat to a calcination reactor 124 for removing HF or other impurities which would otherwise contaminate the products formed in the acidulation reactor 112. In the absence of fossil fuel processes, waste heat may also be used to remove water and dry products for lower cost shipping.

Further provided herein are methods for producing nitrophosphates and mineralized carbon. The methods may be accomplished using any of the systems described above. The methods generally producing nitric acid via a plasma-nitrogen-fixation system, combining the nitric acid with phosphate rock, thereby forming nitrophosphoric acid, and reacting the nitrophosphoric acid with carbon dioxide, water, and ammonia, thereby forming nitrophosphates and mineralized carbon.

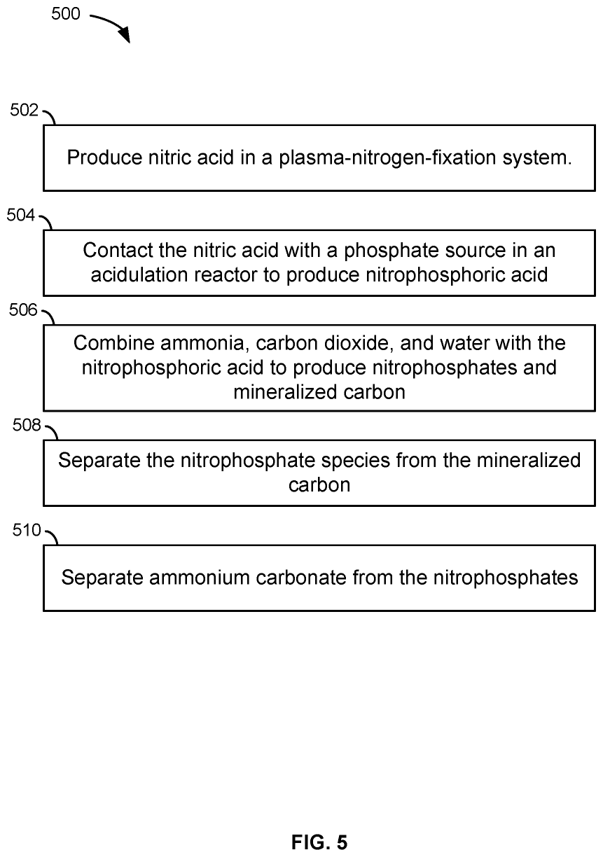

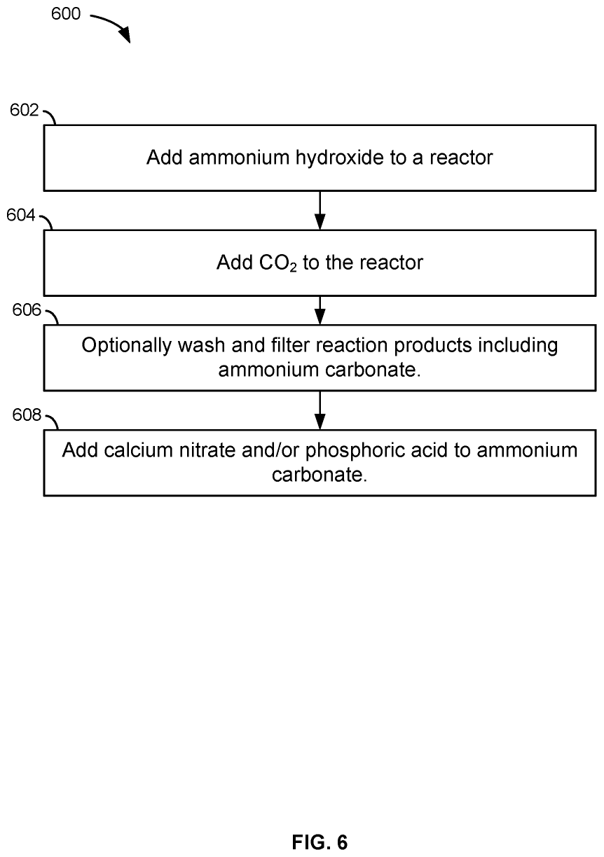

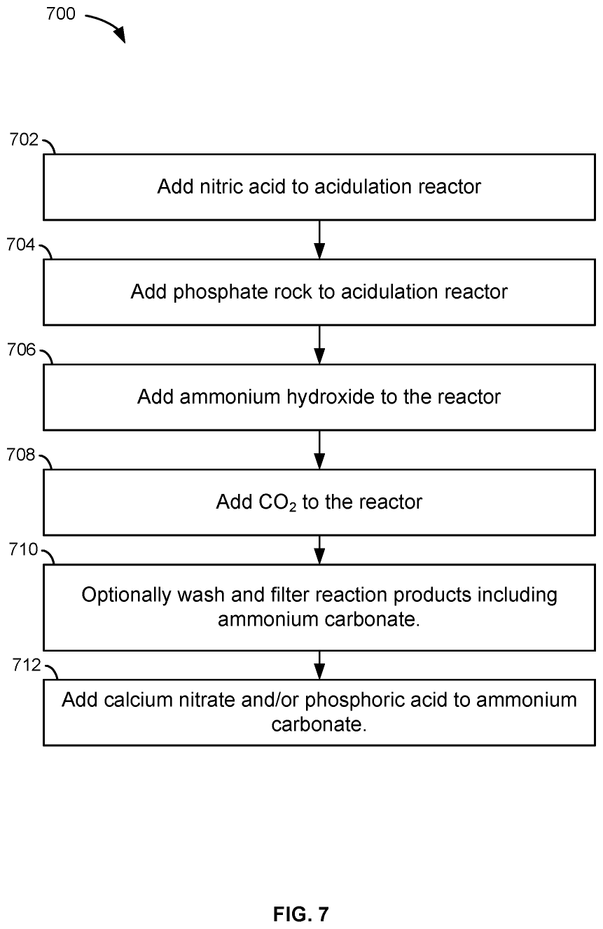

Turning now to FIG. 5, an exemplary method 500 initiates at step 502 by producing nitric acid using a plasma-nitrogen-fixation system. The plasma-nitrogen-fixation system comprises a plasma reactor, an oxidation chamber, and an absorber as described above.

The next step 504 proceeds by contacting the nitric acid with a phosphate source in an acidulation reactor to acidulate the phosphate source. The phosphate source may be phosphate rock. The nitric acid may be mixed with the phosphate source at a ratio of about 6:1 (nitric acid:phosphate source) on a mol basis. In particular, when the phosphate source comprises calcium phosphate, the nitric acid may be mixed with the phosphate source at a ratio of about 6:1 (nitric acid:phosphate source) on a mol basis. The nitric acid may also be mixed with the phosphate source at a ratio of about 5:1 to about 7:1 (nitric acid:phosphate source) on a mol basis.

The next step 506 proceeds by combining ammonia and carbon dioxide with the acidulated species from step 504. The resultant solution includes mineralized carbon and nitrophosphates, including diammonium phosphate and ammonium nitrate. The reactor may be a third reactor as described above. The carbon dioxide may be diluted in air as described above. Preferably, the ammonia is produced on-site in a plasma reactor as described above; however, ammonia may be procured from any source. Step 506 may further comprise adding water to the reactor containing the acidulated species from step 504. Step 506 may further comprise producing ammonium carbonate.

The next step 508 proceeds by separating the resulting nitrophosphate species from step 506 to produce a sequestered mineralized carbon product from the carbon dioxide input. In preferred embodiments, the mineralized carbon product may include calcium carbonate. The separating may be accomplished by a first separator as described in more detail above. In some embodiments, step 508 is accomplished via filtration.

The next step 510 proceeds by separating ammonium carbonate from the effluent of step 508 and extracting nitrophosphate products. The separating may be accomplished by the second separator as described above. In some embodiments, the separating is accomplished via a stripper. Step 510 may further comprise recycling the ammonium carbonate. The ammonium carbonate produced in step 506 may be recycled to the first reactor in step 506 to improve the carbon utilization of the system.

The method may further optionally comprise adding a potassium compound to the nitrophosphates to form an NPK fertilizer composition. However, it will be appreciated that when no nitrophosphates are formed (such as in FIGS. 4B and 4C), this step will not be required.

In an exemplary method 600, in step 602, ammonium hydroxide is added to a reactor (i.e., the fourth reactor). In step 604, CO₂ is added to the reactor. Optionally, air may be mixed with CO₂ to decrease the CO₂ concentration. CO₂ flow may decrease to zero in order to sequester the CO₂ directly from air. A static mixer may be used for a more complete and uniform reaction. The reaction duration and CO₂/Air flow rate may change for complete reaction to form ammonium carbonate. The use of a packed bed reactor may be preferred for this reaction to increase the absorption percentage of CO₂ in the solution and decrease the ammonia slip. An appropriate amount of time may pass for the reaction to arrive at completion. In optional step 606, the product may be washed and filtered. Appropriate amounts of water may be used. In step 608, calcium nitrate or a mixture of calcium nitrate and phosphoric acid are added to the ammonium carbonate formed in step 606. Step 608 may or may not occur in the same reactor as step 602.

In an exemplary method 700, in step 702, nitric acid is added to an acidulation reactor. In step 704, phosphate rock is fed to the acidulation reactor in an appropriate ratio to the nitric acid. A static mixer may be used to achieve a more complete and uniform reaction. Upon complete addition of the phosphate rock, minimal amounts of foaming may be observed. The temperature of the solution may be controlled between 20° C. and 70° C. An appropriate amount of time may pass for the reaction to arrive at completion. In step 706, ammonium hydroxide is fed to the reactor. In step 708, CO₂ is added to the reactor. Optionally, air may be mixed with CO₂ to decrease the CO₂ concentration. CO₂ flow may decrease to zero in order to sequester the CO₂ directly from air. A static mixer may be used to achieve a more complete and uniform reaction. Temperature of the reaction may be kept below 70° C. The reaction duration and CO₂/Air flow rate may be adjusted to achieve a complete reaction. In optional step 710, the product may be washed and filtered. In step 712, calcium nitrate or a mixture of calcium nitrate and phosphoric acid are added to the ammonium carbonate formed in step 708. Appropriate amounts of water may need to be used. Steps 706-712 may be performed in the same reactor or a different reactor than that used in steps 702-704. The use of a packed bed reactor may be preferred for this reaction to increase the absorption percentage of CO₂ in the solution and decrease the ammonia slip.

### EXEMPLARY EMBODIMENTS

Embodiment 1: A system for production of nitrophosphates and mineralized carbon, the system comprising:
(a) a plasma-nitrogen-fixation system comprising:
   i. a plasma reactor for producing oxidized nitrogen species; and,
   ii. an absorber fluidly coupled to the plasma reactor for producing nitric acid from the oxidized nitrogen species;
(b) an acidulation reactor fluidly coupled to the absorber for combining the nitric acid produced in the absorber with a phosphate source, thereby producing nitro-phosphoric acid comprising phosphoric acid and calcium nitrate; the acidulation reactor also fluidly coupled to the plasma-nitrogen-fixation system for recycling NOₓ gases produced in the plasma reactor and the acidulation reactor; and
(c) a third reactor fluidly coupled to the acidulation reactor for combining the nitrophosphoric acid with ammonia, water, and carbon dioxide, thereby producing a solution comprising nitrophosphates and mineralized carbon.

Embodiment 2: The system of embodiment 1, further comprising a first separator fluidly coupled to the third reactor for separating the mineralized carbon from the solution.

Embodiment 3: The system of embodiment 2, wherein the first separator comprises a filter.

Embodiment 4: The system of any one of embodiments 1-3, wherein the mineralized carbon comprises calcium carbonate.

Embodiment 5: The system of any one of embodiments 1-4, wherein the nitrophosphates comprise diammonium phosphate or monoammonium phosphate.

Embodiment 6: The system of any one of embodiments 1-5, further comprising a second separator fluidly coupled to the third reactor for separating ammonium carbonate from the solution.

Embodiment 7: The system of embodiment 6, wherein the second separator is a stripper.

Embodiment 8: The system of any one of embodiments 1-7, wherein the system is powered by electricity.

Embodiment 9: The system of embodiment 8, wherein the electricity is generated from renewable sources.

Embodiment 10: The system of any one of embodiments 1-9, wherein the system is not powered by fossil fuels.

Embodiment 11: The system of any one of embodiments 1-10, wherein the carbon dioxide is diluted in air.

Embodiment 12: The system of embodiment 11, wherein the carbon dioxide has a concentration in air of from about 400 ppm to about 99 mol %.

Embodiment 13: The system of embodiment 11, wherein the carbon dioxide has a concentration in air of less than 400 ppm.

Embodiment 14: The system of embodiment 6, wherein the second separator is further fluidly coupled to the third reactor to recycle the ammonium carbonate back to the third reactor.

Embodiment 15: The system of any one of embodiments 1-14, further comprising a mixer fluidly coupled to the third reactor for mixing the solution comprising nitrophosphates with a potassium compound.

Embodiment 16: The system of embodiment 15, wherein the potassium compound is potassium chloride.

Embodiment 17: The system of embodiment 6, further comprising heat exchanger thermally coupled with the plasma reactor and with the second separator such that waste heat produced by the plasma reactor is provided to the second separator.

Embodiment 18: The system of any one of embodiments 1-17, further comprising a fourth reactor fluidly coupled to the third reactor for combining the carbon dioxide, water, and ammonia.

Embodiment 19: The system of any one of embodiments 1-18, further comprising a fifth reactor for producing ammonia, the fifth reactor fluidly coupled to the third reactor.

Embodiment 20: The system of embodiment 19, wherein the fifth reactor is a plasma reactor.

Embodiment 21: The system of any one of embodiments 1-20, wherein the phosphate source comprises phosphate rock.

Embodiment 22: The system of any one of embodiments 1-21, wherein the plasma-nitrogen-fixation system further comprises an oxidation chamber fluidly coupled to the plasma reactor and to the absorber for further oxidizing partially oxidized nitrogen species produced in the plasma reactor.

Embodiment 23: The system of any one of embodiments 1-22, further comprising a calcination reactor coupled to the acidulation reactor and operable to calcine the phosphate source prior to acidulating the phosphate source and the nitric acid in the acidulation reactor.

Embodiment 24: A method for producing nitrophosphates and mineralized carbon, the method comprising:
(a) producing nitric acid in a plasma-nitrogen fixation system;
(b) contacting the nitric acid produced in step (a) with a phosphate source in an acidulation reactor to produce nitrophosphoric acid; and
(c) combining the nitrophosphoric acid from step (b) with carbon dioxide, water, and ammonia in a third reactor, thereby producing a solution comprising nitrophosphates and mineralized carbon.

Embodiment 25: The method of embodiment 24, further comprising separating the mineralized carbon from the solution.

Embodiment 26: The method of embodiment 25, wherein the separating is accomplished via a filter.

Embodiment 27: The method of any one of embodiments 24-26, further comprising separating ammonium carbonate from the solution.

Embodiment 28: The method of embodiment 27, wherein separating the ammonium carbonate is accomplished via a stripper.

Embodiment 29: The method of embodiment 27, further comprising recycling the ammonium carbonate to the third reactor.

Embodiment 30: The method of any one of embodiments 24-29, further comprising calcining the phosphate source prior to step (b) in a calcination reactor.

Embodiment 31: A system for production of phosphoric acid and calcium nitrate, the system comprising:
(a) a plasma reactor for producing oxidized nitrogen species;
(b) an absorber fluidly coupled to the plasma reactor for producing nitric acid from the oxidized nitrogen species;
(c) an acidulation reactor fluidly coupled to the absorber for combining the nitric acid produced in the absorber with a phosphate source, thereby producing nitro-phosphoric acid comprising phosphoric acid and calcium nitrate; and
(d) a separator fluidly coupled to the acidulation reactor for separating the phosphoric acid from the calcium nitrate.

Embodiment 32: The system of embodiment 31, wherein the system is powered by electricity.

Embodiment 33: The system of embodiment 32, wherein the electricity is generated from renewable sources.

Embodiment 34: The system of any one of embodiments 31-33, wherein the system is not powered by fossil fuels.

Embodiment 35: The system of any one of embodiments 31-34, further comprising a separator for separating the phosphoric acid from the calcium nitrate.

Embodiment 36: The system of embodiment 35, further comprising a heat exchanger thermally coupled to at least one of the plasma reactor, a calcination reactor, or an acidulation reactor, and to the separator such that waste heat produced by the at least one of the plasma reactor, the calcination reactor, or the acidulation reactor is provided to the separator.

Embodiment 37: The system of any one of embodiments 31-36, wherein the phosphate source comprises phosphate rock.

Embodiment 38: The system of any one of embodiments 31-37, further comprising an oxidation chamber fluidly coupled to the plasma reactor and to the absorber for further oxidizing partially oxidized nitrogen species produced in the plasma reactor.

Embodiment 39: The system of any one of embodiments 31-38, wherein the separator comprises a crystallizer for crystalizing the calcium nitrate, a distillation column for removing phosphoric acid.

Embodiment 40: The system of any one of embodiments 31-39, further comprising a calcination reactor coupled to the acidulation reactor and operable to calcine the phosphate source prior to acidulating the phosphate source and the nitric acid in the acidulation reactor.

Embodiment 41: The system of any one of embodiments 31-40, wherein the acidulation reactor is also fluidly coupled to the absorber for recycling NOₓ gases produced in the plasma reactor and the acidulation reactor.

Embodiment 42: A method for producing nitrophosphoric acid, the method comprising:
(a) producing oxidized nitrogen species in a plasma reactor;
(b) contacting the oxidized nitrogen species with water to obtain nitric acid; and
(c) contacting the nitric acid produced in step (b) with a phosphate source in an acidulation reactor to produce nitrophosphoric acid.

Embodiment 43: The method of embodiment 42, wherein the nitrophosphoric acid comprises phosphoric acid and calcium nitrate.

Embodiment 44: The method of embodiment 43, further comprising separating the phosphoric acid from the calcium nitrate.

Embodiment 45: The method of any one of embodiments 42-44, further comprising recycling NOₓ gases produced in the acidulation reactor to the plasma reactor.

Embodiment 46: The method of embodiment 44, wherein the separating comprises one or more of filtration, crystallization, distillation, and centrifugation.

Embodiment 47: The method of embodiment 46, wherein the separating comprises crystallizing the calcium nitrate and distilling the phosphoric acid.

Embodiment 48: A system for production of nitrophosphates and mineralized carbon, the system comprising:
(a) a plasma-nitrogen-fixation system comprising:
   i. a plasma reactor for producing oxidized nitrogen species; and,
   ii. an absorber fluidly coupled to the plasma reactor for producing nitric acid from the oxidized nitrogen species;
(b) an acidulation reactor fluidly coupled to the absorber for combining the nitric acid produced in the absorber with a phosphate source, ammonia, water, and carbon dioxide, thereby producing nitrophosphates and mineralized carbon; the acidulation reactor also fluidly coupled to the plasma-nitrogen-fixation system for recycling NOₓ gases produced in the plasma reactor and the acidulation reactor.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly and synonymously “in one example”, “in one instance”, or “in one aspect” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is claimed:

1. A system for production of nitrophosphates and mineralized carbon, the system comprising:
(a) a plasma-nitrogen-fixation system comprising:
i. a plasma reactor for producing oxidized nitrogen species; and,
ii. an absorber fluidly coupled to the plasma reactor for producing nitric acid from the oxidized nitrogen species;
(b) an acidulation reactor fluidly coupled to the absorber for combining the nitric acid produced in the absorber with a phosphate source, thereby producing nitro-phosphoric acid comprising phosphoric acid and calcium nitrate; the acidulation reactor also fluidly coupled to the plasma-nitrogen-fixation system for recycling NOₓ gases produced in the plasma reactor and the acidulation reactor; and
(c) a third reactor fluidly coupled to the acidulation reactor for combining the nitrophosphoric acid with ammonia, water, and carbon dioxide, thereby producing a solution comprising nitrophosphates and mineralized carbon.

2. The system of claim 1, further comprising a first separator fluidly coupled to the third reactor for separating the mineralized carbon from the solution.

3. The system of claim 2, wherein the first separator comprises a filter.

4. The system of claim 1, wherein the mineralized carbon comprises calcium carbonate.

5. The system of claim 1, wherein the nitrophosphates comprise diammonium phosphate or monoammonium phosphate.

6. The system of claim 1, further comprising a second separator fluidly coupled to the third reactor for separating ammonium carbonate from the solution.

7. The system of claim 6, wherein the second separator is a stripper.

8. The system of claim 1, wherein the system is powered by electricity generated from renewable sources.

9. The system of claim 1, wherein the carbon dioxide is diluted in air.

10. The system of claim 9, wherein the carbon dioxide has a concentration in air of from about 400 ppm to about 99 mol %.

11. The system of claim 9, wherein the carbon dioxide has a concentration in air of less than 400 ppm.

12. The system of claim 6, wherein the second separator is further fluidly coupled to the third reactor to recycle the ammonium carbonate back to the third reactor.

13. The system of claim 1, further comprising a mixer fluidly coupled to the third reactor for mixing the solution comprising nitrophosphates with a potassium compound.

14. The system of claim 13, wherein the potassium compound is potassium chloride.

15. The system of claim 6, further comprising heat exchanger thermally coupled with the plasma reactor and with the second separator such that waste heat produced by the plasma reactor is provided to the second separator.

16. The system of claim 1, further comprising a fourth reactor fluidly coupled to the third reactor for combining the carbon dioxide, water, and ammonia.

17. The system of claim 1, further comprising a fifth reactor for producing ammonia, the fifth reactor fluidly coupled to the third reactor.

18. The system of claim 17, wherein the fifth reactor is a plasma reactor.

19. The system of claim 1, wherein the phosphate source comprises phosphate rock.

20. The system of claim 1, wherein the plasma-nitrogen-fixation system further comprises an oxidation chamber fluidly coupled to the plasma reactor and to the absorber for further oxidizing partially oxidized nitrogen species produced in the plasma reactor.

21. The system of claim 1, further comprising a calcination reactor coupled to the acidulation reactor and operable to calcine the phosphate source prior to acidulating the phosphate source and the nitric acid in the acidulation reactor.

22. A method for producing nitrophosphates and mineralized carbon, the method comprising:
(a) producing nitric acid in a plasma-nitrogen fixation system;
(b) contacting the nitric acid produced in step (a) with a phosphate source in an acidulation reactor to produce nitrophosphoric acid; and
(c) combining the nitrophosphoric acid from step (b) with carbon dioxide, water, and ammonia in a third reactor, thereby producing a solution comprising nitrophosphates and mineralized carbon.

23. The method of claim 22, further comprising separating the mineralized carbon from the solution.

24. The method of claim 23, wherein the separating is accomplished via a filter.

25. The method of claim 22, further comprising separating ammonium carbonate from the solution.

26. The method of claim 25, wherein separating the ammonium carbonate is accomplished via a stripper.

27. The method of claim 25, further comprising recycling the ammonium carbonate to the third reactor.

28. The method of claim 22, further comprising calcining the phosphate source prior to step (b) in a calcination reactor.

29. A system for production of nitrophosphates and mineralized carbon, the system comprising:
(a) a plasma-nitrogen-fixation system comprising:
i. a plasma reactor for producing oxidized nitrogen species; and,
ii. an absorber fluidly coupled to the plasma reactor for producing nitric acid from the oxidized nitrogen species;
(b) an acidulation reactor fluidly coupled to the absorber for combining the nitric acid produced in the absorber with a phosphate source, ammonia, water, and carbon dioxide, thereby producing nitrophosphates and mineralized carbon; the acidulation reactor also fluidly coupled to the plasma-nitrogen-fixation system for recycling NOₓ gases produced in the plasma reactor and the acidulation reactor.
